(19) United States
(12) Patent Application Publication
(10) Pub. No.: US 2006/0268133 A1
(43) Pub. Date: Nov. 30, 2006

(54) Noise reduction circuit

(75) Inventors: Takahiko Murata, Osaka (JP); Takumi Yamaguchi, Kyoto (JP); Shigetaka Kasuga, Osaka (JP)

Correspondence Address: MCDERMOTT WILL & EMERY LLP, 600 13TH STREET, N.W., WASHINGTON, DC, 20005-3096, US

(73) Assignee: MATSUSHITA ELECTRIC INDUSTRIAL CO., LTD.

(21) Appl. No.: 11/378,392

(22) Filed: Mar. 20, 2006

(30) Foreign Application Priority Data
May 24, 2005 (JP) 2005-150875

(51) Int. Cl. H04N 5/217

(52) U.S. Cl. 348/241

(57) ABSTRACT

A noise reduction circuit includes a plurality of electric charge accumulating sections and a plurality of switching sections. In the noise reduction circuit, electric charge in an amount corresponding to a signal containing a noise is accumulated in each of the electric charge accumulating sections, and thereafter the switching sections are turned on to connect the electric charge accumulating sections in parallel or in series with each other, thereby outputting a signal corresponding to the average of, or the sum total of, the amounts of electric charge accumulated in the respective electric charge accumulating sections.

### BACKGROUND OF THE INVENTION

1. Field of the Invention

The present invention relates to noise reduction circuits for reducing noise contained in signals.

2. Description of the Related Art

A conventional noise reduction circuit having the following structure has been known (see “7.3.3 image noise suppression” in p. 115 in “Digital signal processing of images” by Fukinuki Takahiko (published by The Nikkan Kogyo Shimbun Co., Ltd.)).

FIGS. 18A to 18C are views for explaining the basic principle of conventional noise suppression. A plurality of image data sets (e.g., TV signals) shown in FIG. 18A are stored in frame memories shown in FIG. 18B, and an average for the n frames is calculated. For a signal component, if there is no variation among the frames, the original signal component value is output as the average value. For a noise, on the other hand, since it is considered that there is no correlation among the frames, the average noise amplitude is attenuated to 1/n^{0.5} as shown in FIG. 18C.

### SUMMARY OF THE INVENTION

However, in the conventional noise suppression, the expensive frame memories must be provided outside the noise reduction circuit.

In view of the above, it is therefore an object of the present invention to provide a noise reduction circuit which is capable of noise suppression without the need for the provision of expensive frame memories outside the noise reduction circuit.

In order to achieve the above object, a first inventive noise reduction circuit includes a plurality of electric charge accumulating sections and a plurality of switching sections, wherein electric charge in an amount corresponding to a signal containing a noise is accumulated in each of the electric charge accumulating sections, and thereafter the switching sections are turned on to connect the electric charge accumulating sections in parallel with each other, thereby outputting a signal corresponding to the average of the amounts of electric charge accumulated in the respective electric charge accumulating sections.

In the first inventive noise reduction circuit, for the signal component, the original value is output as the average value. For the noise, on the other hand, since it is considered that there is no correlation among the electric charge accumulating sections, the average amplitude is attenuated to 1/n^{0.5}, where n is the number of electric charge accumulating sections. That is, the noise can be reduced without the need for external memories.

In the first inventive noise reduction circuit, the electric charge accumulating sections preferably form at least a first section group and a second section group, and the first section group preferably outputs the signal corresponding to the average amount of electric charge, and electric charge in an amount corresponding to that output signal is preferably accumulated in one of the electric charge accumulating sections in the second section group. Then, the number of electric charge accumulating sections necessary to achieve the same noise-reduction effect is reduced significantly.

A second inventive noise reduction circuit includes a plurality of electric charge accumulating sections and a plurality of switching sections, wherein electric charge in an amount corresponding to a signal containing a noise is accumulated in each of the electric charge accumulating sections, and thereafter the switching sections are turned on to connect the electric charge accumulating sections in series with each other, thereby outputting a signal corresponding to the sum total of the amounts of electric charge accumulated in the respective electric charge accumulating sections.

In the second inventive noise reduction circuit, when the number of electric charge accumulating sections is n, the signal component is increased by n times by summing the amounts of electric charge. For the noise, on the other hand, since it is considered that there is no correlation among the electric charge accumulating sections, the noise is only n^{0.5} times the original, despite the summing of the amounts of electric charge. That is, the noise can be reduced substantially without the need for external memories.

In the second inventive noise reduction circuit, the electric charge accumulating sections preferably form at least a first section group and a second section group, and the first section group preferably outputs the signal corresponding to the total amount of electric charge, and electric charge in an amount corresponding to that output signal is preferably accumulated in one of the electric charge accumulating sections in the second section group. Then, the number of electric charge accumulating sections necessary to achieve the same noise-reduction effect is reduced significantly.

In the first or second inventive noise reduction circuit, an amplifier circuit for amplifying the signal containing the noise is preferably disposed before the electric charge accumulating sections. Then, the influence of thermal noise is decreased at the input side, whereby the noise at the time of the input is significantly reduced.

In the first or second inventive noise reduction circuit, a noise cancel circuit for performing noise removal using a difference between two signals is preferably disposed before the electric charge accumulating sections. Then, a noise that contains fixed-pattern noise (fixed noise occurring due to circuit variations) is reduced considerably.

As described above, when applied to image processing and the like, the present invention, which relates to a noise reduction circuit for reducing noise contained in a signal, is effective in significantly reducing the noise as well as the number of internal electric charge accumulating sections without the need for external memories, and thus functions very effectively.

### BRIEF DESCRIPTION OF THE DRAWINGS

FIG. 1 shows the circuit configuration of a noise reduction circuit according to a first embodiment of the present invention.

FIG. 2 shows timing for operating the noise reduction circuit according to the first embodiment of the present invention.

FIG. 3 shows the circuit configuration of a noise reduction circuit according to a second embodiment of the present invention.

FIG. 4 shows timing for operating the noise reduction circuit according to the second embodiment of the present invention.

FIG. 5 shows the circuit configuration of a noise reduction circuit according to a third embodiment of the present invention.

FIG. 6 shows timing for operating the noise reduction circuit according to the third embodiment of the present invention.

FIG. 7 shows the circuit configuration of a noise reduction circuit according to a fourth embodiment of the present invention.

FIG. 8 shows timing for operating the noise reduction circuit according to the fourth embodiment of the present invention.

FIG. 9 shows the circuit configuration of a noise reduction circuit (obtained by providing an amplifier circuit in a step before the noise reduction circuit of the first embodiment) according to a fifth embodiment of the present invention.

FIG. 10 shows the circuit configuration of a noise reduction circuit (obtained by providing an amplifier circuit in a step before the noise reduction circuit of the second embodiment) according to the fifth embodiment of the present invention.

FIG. 11 shows the circuit configuration of a noise reduction circuit (obtained by providing an amplifier circuit in a step before the noise reduction circuit of the third embodiment) according to the fifth embodiment of the present invention.

FIG. 12 shows the circuit configuration of a noise reduction circuit (obtained by providing an amplifier circuit in a step before the noise reduction circuit of the fourth embodiment) according to the fifth embodiment of the present invention.

FIG. 13 shows the circuit configuration of a noise reduction circuit (obtained by providing a noise cancel circuit in a step before the noise reduction circuit of the first embodiment) according to a sixth embodiment of the present invention.

FIG. 14 shows timing for operating the noise reduction circuit according to the sixth embodiment of the present invention.

FIG. 15 shows the circuit configuration of a noise reduction circuit (obtained by providing a noise cancel circuit in a step before the noise reduction circuit of the second embodiment) according to the sixth embodiment of the present invention.

FIG. 16 shows the circuit configuration of a noise reduction circuit (obtained by providing a noise cancel circuit in a step before the noise reduction circuit of the third embodiment) according to the sixth embodiment of the present invention.

FIG. 17 shows the circuit configuration of a noise reduction circuit (obtained by providing a noise cancel circuit in a step before the noise reduction circuit of the fourth embodiment) according to the sixth embodiment of the present invention.

FIGS. 18A to 18C are views for explaining the basic principle of conventional noise suppression.

### DETAILED DESCRIPTION OF THE INVENTION

(First Embodiment)

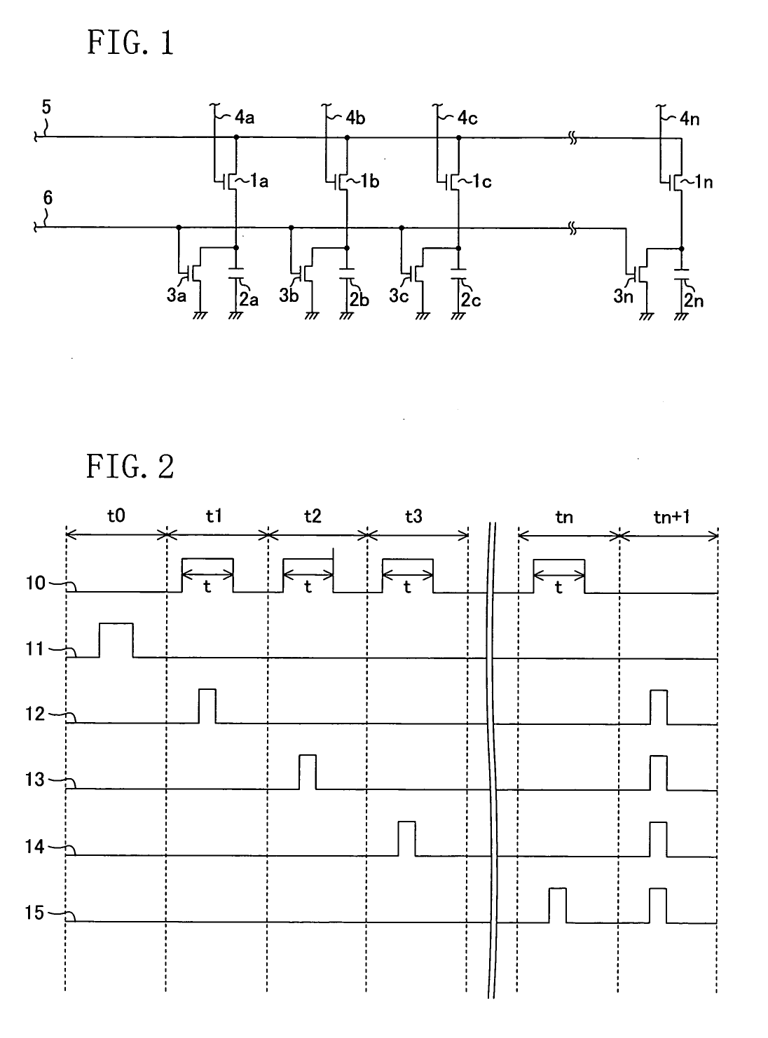

Hereinafter, a noise reduction circuit according to a first embodiment of the present invention will be described with reference to the accompanying drawings. FIG. 1 shows the circuit configuration of the noise reduction circuit of this embodiment. In FIG. 1, the reference numeral 1 refers to switching sections; 2 to electric charge accumulating sections; 3 to switching sections; 4 to gate terminals of the switching sections 1; 5 to a signal line; and 6 to a gate terminal of the switching sections 3. As shown in FIG. 1, in the noise reduction circuit of this embodiment, a single switching section 1, a single switching section 3, and a single electric charge accumulating section 2 form a unit component, and n such unit components are included (the reference numeral for each section in the configuration is followed by a character: a, b, c, . . . n). Specifically, the drains of the switching sections 1a to 1n are connected to the signal line 5, while the source of each of the switching sections 1a to 1n is connected to one terminal of a corresponding one of the electric charge accumulating sections 2a to 2n. The other terminals of the respective electric charge accumulating sections 2a to 2n are connected to GND. The gates of the respective switching sections 1a to 1n are connected to the corresponding gate terminals 4a to 4n, respectively. The drains of the switching sections 3a to 3n are connected to the respective corresponding connection points between the switching sections 1a to 1n and the electric charge accumulating sections 2a to 2n, while the sources of the switching sections 3a to 3n are connected to the GND. The gates of the switching sections 3a to 3n are connected to the common gate terminal 6.

Now, it will be described how the noise reduction circuit of this embodiment operates. FIG. 2 shows timing for operating the noise reduction circuit of this embodiment. In FIG. 2, the reference numeral 10 refers to a signal on the signal line 5; 11 to a signal that is applied to the gate terminal 6 of the switching sections 3a to 3n; 12 to a signal that is applied to the gate terminal 4a of the switching section 1a; 13 to a signal that is applied to the gate terminal 4b of the switching section 1b; 14 to a signal that is applied to the gate terminal 4c of the switching section 1c; and 15 to a signal that is applied to the gate terminal 4n of the switching section 1n.

As shown in FIG. 2, in a time period t0, the signal 11 to the gate terminal 6 of the switching sections 3a to 3n is set to HIGH so as to turn on the switching sections 3a to 3n, whereby the electric charge in the electric charge accumulating sections 2a to 2n is discharged so that the electric charge accumulating sections 2a to 2n are empty (i.e., the amount of electric charge accumulated in each of the electric charge accumulating sections 2a to 2n is zero). Next, in a time interval t in a time period t1, during which the signal 10 containing noise is output to the signal line 5, the signal 12 that is applied to the gate terminal 4a of the switching section 1a is set to HIGH. This causes the switching section 1a to turn on, whereby electric charge in an amount corresponding to the signal 10 output to the signal line 5 is accumulated in the electric charge accumulating section 2a. Likewise, in time intervals t in the respective time periods t2, t3, . . . tn, during each of which the signal 10 containing noise is output to the signal line 5, the respective signals 13, 14, and 15 that are applied to the gate terminals 4b, 4c, . . . 4n of the respective switching sections 1b, 1c, . . . 1n are set to HIGH. As a result, the switching sections 1b, 1c, . . . 1n turn on respectively in the time intervals t in the respective time periods t2, t3, . . . tn, whereby electric charge in an amount corresponding to the signal 10 output to the signal line 5 is accumulated in each of the electric charge accumulating sections 2b, 2c, . . . 2n. At this time, the value of the amount of electric charge accumulated in each of the electric charge accumulating sections 2a, 2b, 2c, . . . 2n does not change, and for the noise, there is no correlation among the electric charge accumulating sections 2.

Next, the signals 12, 13, 14, and 15 that are applied to the respective gate terminals 4a, 4b, 4c, . . . 4n are set to HIGH in a time period tn+1, so that the switching sections 1a, 1b, 1c, . . . 1n turn on to thereby connect the electric charge accumulating sections 2a, 2b, 2c, . . . 2n in parallel with each other. As a result, the amounts of electric charge accumulated in the respective electric charge accumulating sections 2a, 2b, 2c, . . . 2n are equalized so as to have the average value thereof, while a signal corresponding to that average amount of electric charge is output to the signal line 5. At this time, the signal component of the signal output to the signal line 5 shows the average value of the signal components of the electric charge accumulating sections 2a, 2b, 2c, . . . 2n and does not change from the signal component of the original signal 10. On the other hand, the value of the noise of the signal output to the signal line 5 is the mean square value of the noises of the electric charge accumulating sections 2a, 2b, 2c, . . . 2n (for example, the noise of the signal output to the signal line 5 is (1/n×((Na)²+(Nb)²+ . . . +(Nn)²))^{0.5}, where the noises of the respective electric charge accumulating sections 2a, 2b, 2c, . . . 2n are Na, Nb, Nc, Nn,) and is therefore attenuated to be 1/n^{0.5} times the noise of the original signal 10 (where n is the number of electric charge accumulating sections 2). That is, the SIN ratio substantially increases by n^{0.5} times. For instance, when n=100, the S/N ratio increases by 10 times.

As described above, according to the first embodiment, it is possible to reduce the noise with no external memories provided.

(Second Embodiment)

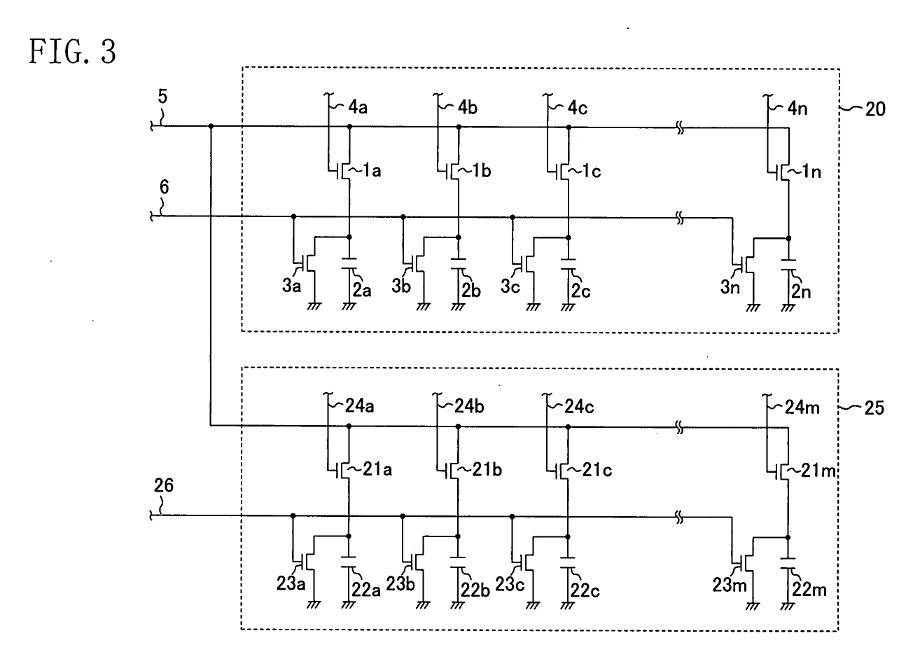

Hereinafter, a noise reduction circuit according to a second embodiment of the present invention will be described with reference to the accompanying drawings. FIG. 3 shows the circuit configuration of the noise reduction circuit of this embodiment. In this embodiment, since a configuration in a dotted box 20 in FIG. 3 is the same as the configuration of the first embodiment show in FIG. 1, descriptions thereof will be omitted herein. A configuration in a dotted box 25 is also similar to the configuration in the dotted box 20. Specifically, in FIG. 3, the reference numeral 21 refers to switching sections; 22 to electric charge accumulating sections; 23 to switching sections; 24 to gate terminals of the switching sections 21; and 26 to a gate terminal of the switching sections 23. As shown in FIG. 3, in the configuration in the dotted box 25, a single switching section 21, a single switching section 23, and a single electric charge accumulating section 22 form a unit component and m such unit components are included (the reference numeral for each section in the configuration is followed by a character: a, b, c, . . . m). The drains of the switching sections 21a to 21m, like the drains of the switching sections 1a to 1n, are connected to a common signal line 5, while the source of each of the switching sections 21a to 21m is connected to one terminal of a corresponding one of the electric charge accumulating sections 22a to 22m. The other terminals of the respective electric charge accumulating sections 22a to 22m are connected to GND. The gates of the respective switching sections 21a to 21m are connected to the corresponding gate terminals 24a to 24m, respectively. The drains of the switching sections 23a to 23m are connected to the respective corresponding connection points between the switching sections 21a to 21m and the electric charge accumulating sections 22a to 22m, while the sources of the respective switching sections 23a to 23m are connected to the GND. The gates of the switching sections 23a to 23m are connected to the common gate terminal 26.

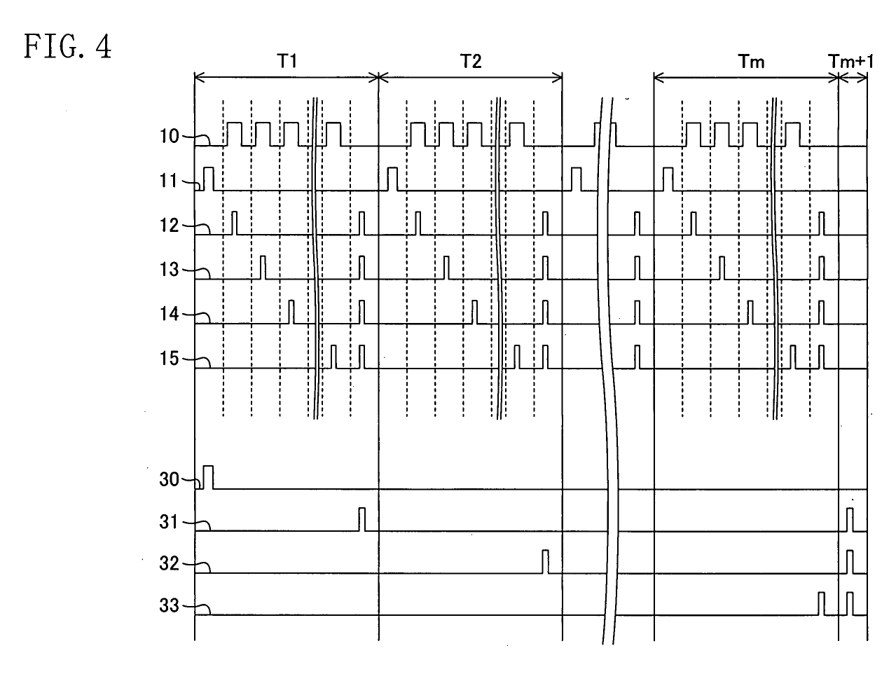

Now, it will be described how the noise reduction circuit of this embodiment operates. FIG. 4 shows timing for operating the noise reduction circuit of this embodiment. In FIG. 4, signals 10 to 15 are the same as those of the first embodiment shown in FIG. 2, and the reference numeral 30 refers to a signal that is applied to the gate terminal 26 of the switching sections 23a to 23m, 31 to a signal that is applied to the gate terminal 24a of the switching section 21a, 32 to a signal that is applied to the gate terminal 24b of the switching section 21b, and 33 to a signal that is applied to the gate terminal 24m of the switching section 21m. Also, in FIG. 4, time periods T1 to Tm correspond to the time periods t0 to tn+1 shown in FIG. 2. During the period of time from the time period T1 to the time period Tm, the operation performed during the period of time from the time period t0 to the time period tn+1 shown in FIG. 2 is repeated m times.

As shown in FIG. 4, in this embodiment, the signal 30 to the gate terminal 26 of the switching sections 23a to 23m is first set to HIGH in the time period t0 in the time period T1 to turn on the switching sections 23a to 23m, whereby the electric charge in the electric charge accumulating sections 22a to 22m is discharged for initialization (i.e., the amount of electric charge accumulated in each of the electric charge accumulating sections 22a to 22m is zero). Next, during the period of time from the time period t1 to the time period tn in the time period T1, the same operation as that of the first embodiment is performed. Then, in the time period tn+1 in the time period T1, the signal 31 that is applied to the gate terminal 24a of the switching section 21a is set to HIGH so as to turn on the switching section 21a. At this point in time, since the switching sections 1a, . . . 1n are also conductive, the electric charge accumulating sections 2a, . . . 2n and the electric charge accumulating section 22a are connected in parallel with each other. At this time, if the electric charge accumulating sections 2 and 22 have the same capacitance value C and the amount of electric charge accumulated in each of the electric charge accumulating sections 2 is Q, the amount of electric charge that is accumulated in the electric charge accumulating section 22a is Q×(n/(n+1)), and the noise is thus attenuated to be 1/(n+1)^{0.5} times the noise of the original signal 10 (“n+1” is the total number of electric charge accumulating sections 2 and 22a).

Subsequently, during the period of time from the time period T2 to the time period Tm, the same operation as that performed in the time period T1 is repeatedly performed, whereby the amount of electric charge Q×(n/(n+1)) is accumulated in each of the electric charge accumulating sections 22b, . . . 22m, while the noise is attenuated to be 1/(n+1)^{0.5} times the original as described above.

Thereafter, in a time period Tm+1, the signals 31, 32 and 33 that are applied to the respective gate terminals 24a, . . . 24m are set to HIGH, so that the switching sections 21a, . . . 21m turn on to connect the electric charge accumulating sections 22a, . . . 22m in parallel with each other. At this point in time, the amounts of electric charge accumulated in the respective electric charge accumulating sections 22a, . . . 22m are equalized so as to have the average value thereof, while a signal corresponding to that average amount of electric charge is output to the signal line 5. At this time, the value of the signal output to the signal line 5 is Q/C×(n/(n+1)), and the noise thereof is attenuated to be 1/((n+1)×m)^{0.5} times the original noise. For instance, when n=10 and m=10, the noise is decreased to 1/(110)^{0.5}(=about 1/10.5).

As described above, the number of electric charge accumulating sections required to decrease the noise by a factor of 10 is 100 in the first embodiment, while in the second embodiment, it is only 20(n=10, m=10). That is, in the second embodiment, the number of electric charge accumulating sections necessary to achieve the same noise-reduction effect is reduced significantly.

(Third Embodiment)

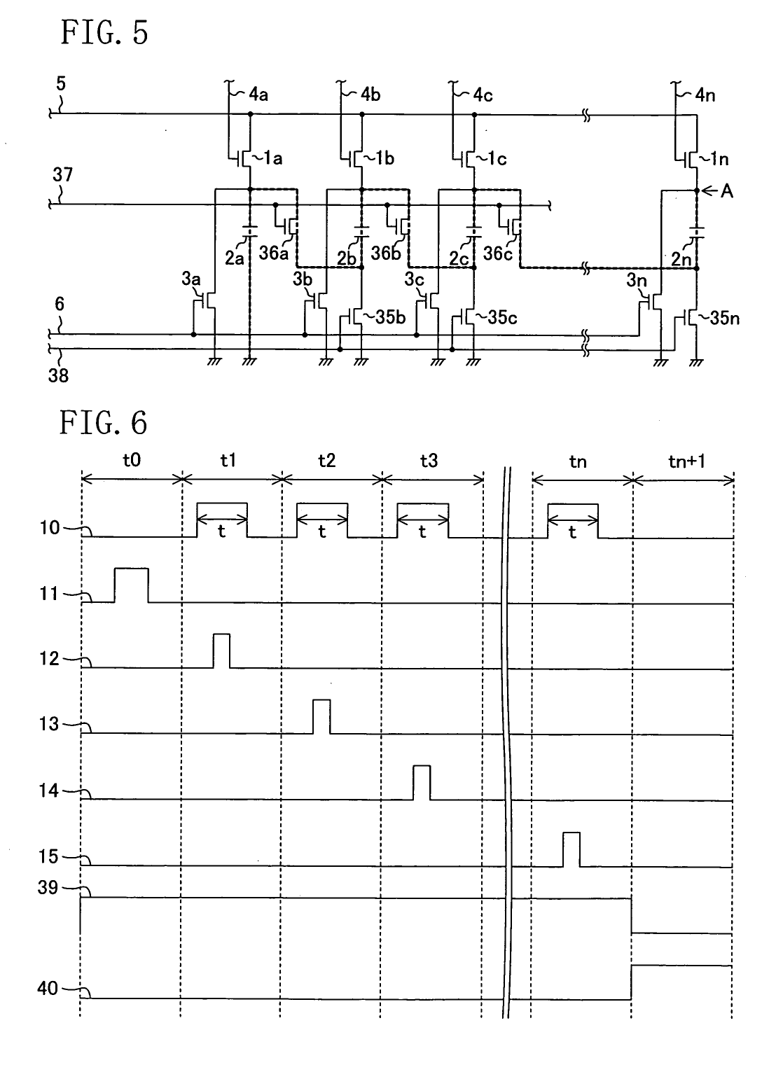

Hereinafter, a noise reduction circuit according to a third embodiment of the present invention will be described with reference to the accompanying drawings. FIG. 5 shows the circuit configuration of the noise reduction circuit of this embodiment. In FIG. 5, the reference numerals 1 to 6 refer to the same members as those of the first embodiment shown in FIG. 1 (descriptions of the same circuit configuration as that of the first embodiment will be omitted herein); 35 and 36 refer to switching sections; 37 to a gate terminal of the switching sections 36; and 38 to a gate terminal of the switching sections 35. As shown in FIG. 5, the switching sections 35b, . . . 35n are respectively connected between the electric charge accumulating sections 2b, . . . 2n and GND, and the gates of the respective switching sections 35b, . . . 35n are connected to the common gate terminal 38. However, the terminal of the electric charge accumulating section 2a which is away from the switching section 1a is always connected with the GND. The switching sections 36a, 36b, . . . 36n−1 are connected between the electric charge accumulating sections 2a and 2b, between 2b and 2c, . . . between 2n−1 and 2n, respectively. The gates of the respective switching sections 36a, 36b, . . . 36n−1 are connected to the common gate terminal 37. More specifically, the drain of the switching section 36a is connected to the connection point between the electric charge accumulating section 2a and the switching section 1a, while the source of the switching section 36a is connected to the connection point between the electric charge accumulating section 2b and the switching section 35b. Likewise, the drains of the respective switching sections 36b, . . . 36n−1 are connected with the respective connection points between the electric charge accumulating sections 2b, . . . 2n−1 and the switching sections 1b, . . . 1n−1, while the sources of the respective switching sections 36b, . . . 36n−1 are connected to the respective connections points between the electric charge accumulating sections 2c, . . . 2n and the switching sections 35c, . . . 35n.

Now, it will be described how the noise reduction circuit of this embodiment operates. FIG. 6 shows timing for operating the noise reduction circuit of this embodiment. In FIG. 6, signals 10 to 15 and time periods t0 to tn+1 are the same as those in the first embodiment shown in FIG. 2, and the reference numeral 39 refers to a signal that is applied to the gate terminal 38 of the switching sections 35b, . . . 35n, and the reference numeral 40 refers to a signal that is applied to the gate terminal 37 of the switching sections 36a, . . . 36n−1.

As shown in FIG. 6, in this embodiment, during the period of time from the time period t0 to the time period tn, electric charge in an amount corresponding to the signal 10 output to the signal line 5 is accumulated in each of the electric charge accumulating sections 2a, 2b, . . . 2n as in the first embodiment. At this time, the value of the amount of electric charge (Q) accumulated in each of the electric charge accumulating sections 2a, 2b, 2c, . . . 2n does not change, and for the noise, there is no correlation among the electric charge accumulating sections 2.

Next, during the time period tn+1, the signal 11 that is applied to the gate terminal 6 of the switching sections 3a to 3n, the signals 12 to 15 that are applied to the respective gate terminals 4a to 4n, and the signal 39 that is applied to the gate terminal 38 of the switching sections 35b to 35n are set to LOW, while the signal 40 that is applied to the gate terminal 37 of the switching sections 36a to 36n−1 is set to HIGH, whereby the switching sections 36a to 36n−1 turn on to connect the electric charge accumulating sections 2a to 2n in series with each other. That is, as indicated by the bold dashed lines in FIG. 5, the n electric charge accumulating sections 2 are connected in series with each other between the GND and a point A. At this time, if the electric charge accumulating sections 2 have the same capacitance value C and the amount of electric charge accumulated in each of the electric charge accumulating sections 2 is Q, the output at the point A is (Q/C×n), which is n times the original signal 10, while the noise is n^{0.5} times the noise of the original signal 10. Therefore, the S/N ratio increases by n/n^{0.5}=n^{0.5} times.

As described above, in the third embodiment, the noise is substantially reduced with no external memories provided.

(Fourth Embodiment)

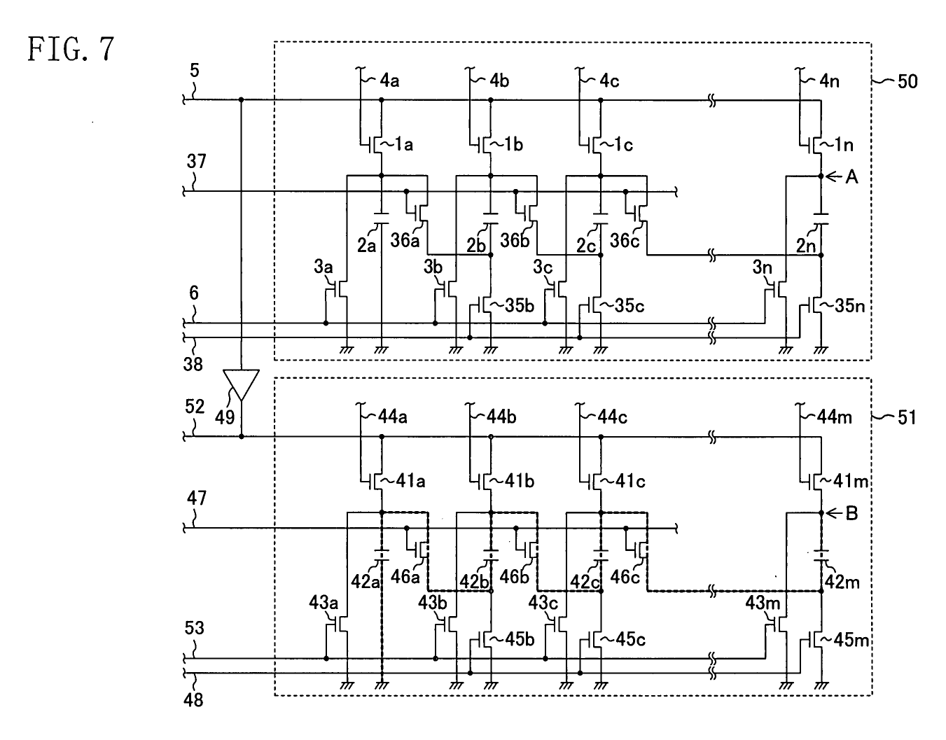

Hereinafter, a noise reduction circuit according to a fourth embodiment of the present invention will be described with reference to the accompanying drawings. FIG. 7 shows the circuit configuration of the noise reduction circuit of this embodiment. In this embodiment, since a configuration in a dotted box 50 shown in FIG. 7 is the same as the configuration of the third embodiment shown in FIG. 5, descriptions thereof will be omitted herein. A configuration in a dotted box 51 is also similar to the configuration in the dotted box 50. More specifically, in FIG. 7, the reference numerals 41, 43, 45, and 46 refer to switching sections; 42 to electric charge accumulating sections; 44 to gate terminals of the switching sections 41; 47 to a gate terminal of the switching sections 46; 48 to a gate terminal of the switching sections 45; 49 to an impedance converter; 52 to a signal line; and 53 to a gate terminal of the switching sections 43. As shown in FIG. 7, in the configuration in the dotted box 51, a single switching section 41, a single switching section 43, and a single electric charge accumulating section 42 form a unit component, and m such unit components are included (the reference numeral for each section in the configuration is followed by a character: a, b, c, . . . m). The drains of the switching sections 41a to 41m are connected to the common signal line 52, while the source of each of the switching sections 41a to 41m is connected to one terminal of a corresponding one of the electric charge accumulating sections 42a to 42m. The gates of the respective switching sections 41a to 41m are connected to the corresponding gate terminals 44a to 44m, respectively. The drains of the switching sections 43a to 43m are connected to the respective corresponding connection points between the switching sections 41a to 41m and the electric charge accumulating sections 42a to 42m, while the sources of the switching sections 43a to 43m are connected to the GND. The gates of the switching sections 43ato 43m are connected to the common gate terminal 53. The switching sections 45b to 45m are respectively connected between the other terminals of the corresponding electric charge accumulating sections 42b to 42m and the GND. The gates of the switching sections 45b to 45m are connected to the common gate terminal 48. However, the other terminal of the electric charge accumulating section 42a (i.e., the terminal away from the switching section 41a) is always connected to the GND. The switching sections 46a, 46b, . . . 46m−1 are connected between the electric charge accumulating sections 42a and 42b, between 42b and 42c, . . . between 42m−1 and 42m, respectively. The gates of the respective switching sections 46a, 46b, . . . 46m−1 are connected to the common gate terminal 47. More specifically, the drain of the switching section 46a is connected to the connection point between the electric charge accumulating section 42a and the switching section 41a, while the source of the switching section 46a is connected to the connection point between the electric charge accumulating section 42b and the switching section 45b. Likewise, the drains of the respective switching sections 46b, . . . 46m−1 are connected to the respective connection points between the electric charge accumulating sections 42b, . . . 42m−1 and the switching sections 41b, . . . 41m−1, while the sources of the respective switching sections 46b, . . . 46m−1 are connected to the respective connections points between the electric charge accumulating sections 42c, . . . 42n and the switching sections 45c, . . . 45m. The signal lines 5 and 52 are connected with each other via the impedance converter 49. Specifically, the input of the impedance converter 49 is connected to the signal line 5, while the output thereof is connected to the signal line 52.

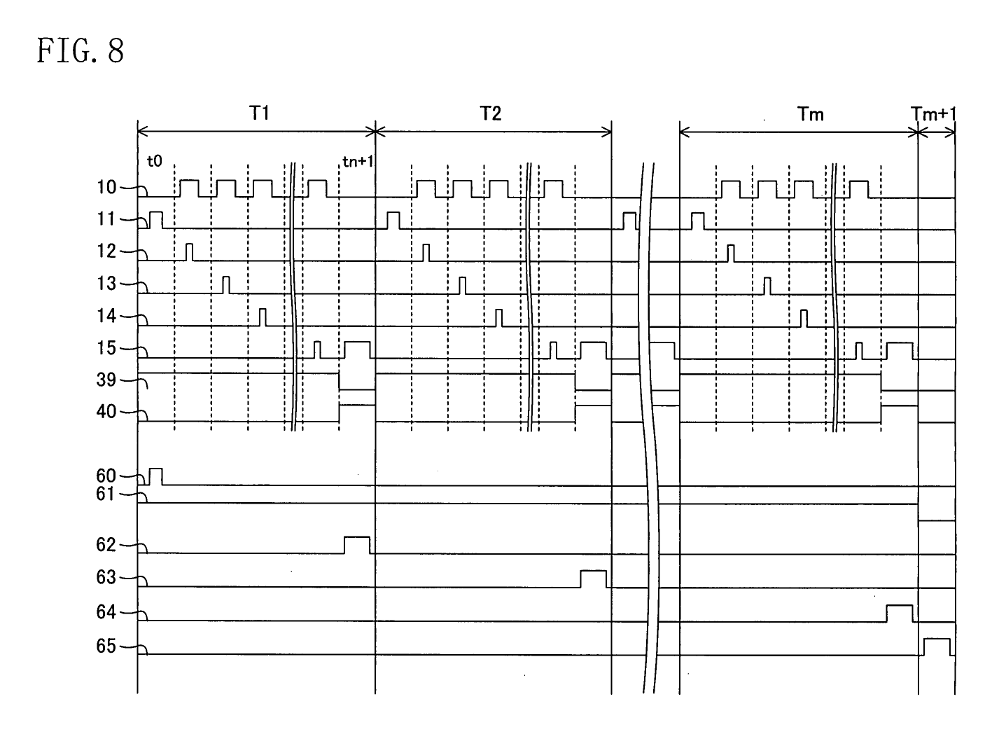

Now, it will be described how the noise reduction circuit of this embodiment operates. FIG. 8 shows timing. for operating the noise reduction circuit of this embodiment. In FIG. 8, signals 10 to 15, 39 and 40 are the same as those of the third embodiment shown in FIG. 6, and the reference numeral 60 refers to a signal that is applied to the gate terminal 53 of the switching sections 43a to 43m, 61 to a signal that is applied to the gate terminal 48 of the switching sections 45a to 45m, 62 to a signal that is applied to the gate terminal 44a of the switching section 41a, 63 to a signal that is applied to the gate terminal 44b of the switching section 41b, 64 to a signal that is applied to the gate terminal 44m of the switching section 41m, and 65 to a signal that is applied to the gate terminal 47 of the switching sections 46a, . . . 46m−1. Also, in FIG. 8, time periods T1 to Tm correspond to the time periods t0 to tn+1 shown in FIG. 6. During the period of time from the time period T1 to the time period Tm, the operation performed during the period of time from the time period t0 to the time period tn+1 shown in FIG. 6 is repeated m times.

In this embodiment, as shown in FIG. 8, the signal 60 to the gate terminal 53 of the switching sections 43a to 43m is first set to HIGH in a time period t0 in the time period T1 so as to turn on the switching sections 43a to 43m, whereby the electric charge in the electric charge accumulating sections 42a to 42m is discharged for initialization (i.e., the amount of electric charge accumulated in each of the electric charge accumulating sections 42a to 42m is zero). Next, during the period of time from a time period t1 to a time period tn in the time period T1, the same operation as that of the third embodiment is performed. Then, in a time period tn+1 in the time period T1, the signal 11 that is applied to the gate terminal 6 of the switching sections 3a to 3n, the signals 12 to 14 that are applied to the gate terminals 4a to 4n−1 except for the gate terminal 4n, and the signal 39 that is applied to the gate terminal 38 of the switching sections 35b to 35n are set to LOW, while the signal 40 that is applied to the gate terminal 37 of the switching sections 36a to 36n−1 is set to HIGH. This causes the switching sections 36a to 36n−1 to turn on, whereby the electric charge accumulating sections 2a to 2n are connected in series with each other. At this time, if the signal 15 that is applied to the gate terminal 4n is set to HIGH, the switching section 1n turns on and the output at the point A (see the third embodiment) is thereby input into the impedance converter 49 through the signal line 5 and then transmitted to the signal line 52. Also, at this time, if the signal 62 that is applied to the gate terminal 44a of the switching section 41a is set to HIGH, the switching section 41a turns on and the output of the impedance converter 49 is transmitted to the electric charge accumulating section 42a through the signal line 52. That is, the amount of electric charge corresponding to the output (Q/C×n) at the point A is accumulated in the electric charge accumulating section 42a. The noise in that amount of electric charge is n^{0.5} times the noise of the original signal 10.

Subsequently, during the period of time from the time period T2 to the time period Tm, the same operation as that performed in the time period T1 is repeated. As a result, the amount of electric charge (Q/C×n) is accumulated in each of the electric charge accumulating sections 42b, . . . 42m. The noise in that amount of electric charge is n^{0.5} times the noise of the original signal 10.

Thereafter, in a time period Tm+1, the signal 61 to the gate terminal 48 of the switching sections 45a to 45m is set to LOW and the signal 65 to the gate terminal 47 of the switching sections 46a to 46m−1 is set to HIGH, whereby the switching sections 46a to 46m−1 turn on to thereby connect the electric charge accumulating sections 42a to 42m in series with each other. That is, as indicated by the bold dashed lines in FIG. 7, the m electric charge accumulating sections 42 are connected in series with each other between the GND and a point B. At this time, the output at the point B is (Q/C×n×m), which is n×m times the original signal 10, while the noise is (n×m)^{0.5} times the noise of the original signal 10. Therefore, the S/N ratio increases by (n×m)/(n×m)^{0.5}=(n×m)^{0.5} times.

As described above, the number of electric charge accumulating sections required to increase the S/N ratio by a factor of 10 is 100 in the third embodiment, while in the fourth embodiment, it is just 20(n=10, m=10). That is, in the fourth embodiment, the number of electric charge accumulating sections necessary to achieve the same noise-reduction effect is reduced significantly.

(Fifth Embodiment)

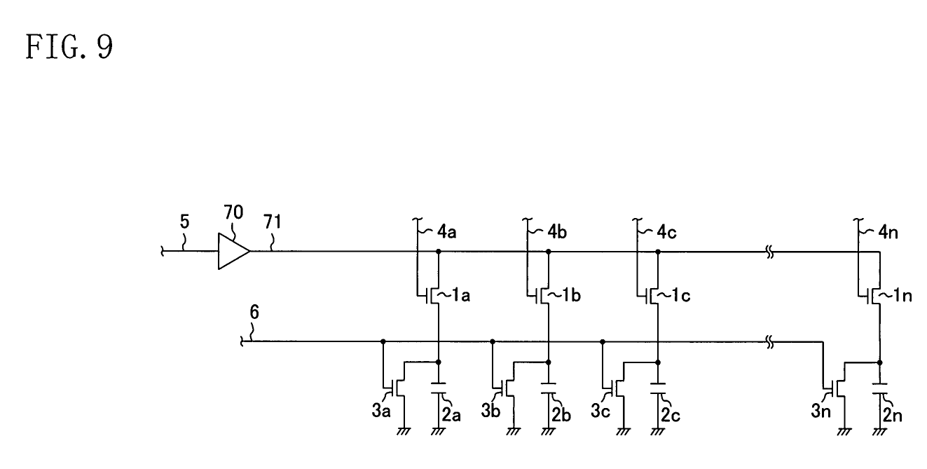

Hereinafter, a noise reduction circuit according to a fifth embodiment of the present invention will be described with reference to the accompanying drawings. FIG. 9 shows the circuit configuration of the noise reduction circuit of this embodiment. In FIG. 9, the same members as those of the first embodiment shown in FIG. 1 are designated by the same reference numerals and descriptions thereof will be thus omitted herein. As shown in FIG. 9, this embodiment differs from the first embodiment shown in FIG. 1 in that a signal line 5 is connected to the input of an amplifier circuit 70 and the output of the amplifier circuit 70 is connected to an input line 71 of the noise reduction circuit. In other words, this embodiment is characterized in that the amplifier circuit 70 for amplifying a signal containing a noise is disposed in a step before a step in which electric charge accumulating sections 2a to 2n are provided.

In the first embodiment, when the switching sections 1 or 3 are operated, thermal noise is generated and electric charge in an amount corresponding to that thermal noise is added to the electric charge accumulating sections 2. For example, when the capacitance value of each electric charge accumulating section 2 is 1 pF, the value of the thermal noise is about 65 μV. Therefore, in the first embodiment, the amount of electric charge corresponding to a thermal noise of 112 μV(≈(65×65+65×65+65×65)^{0.5}) in total is added to the electric charge accumulating sections 2 by three switching operations, which are respectively performed at the time of initialization, in which the switching sections 3 are operated, and at the time of electric charge accumulation and at the time of electric charge averaging, in which the switching sections 1 are operated. In the noise reduction circuit in which the 100 electric charge accumulating sections 2 are used, a noise of about 11.2 μV is newly added as the value of reduced thermal noise.

Specific exemplary calculations will be described below. For example, if the signal component and the noise of the signal 10 on the signal line 5 are 100 μV and 10 μV, respectively, and the gain of the amplifier circuit 70 is 100, then the S/N ratio for the signal line 5 is 10. In cases as in the first embodiment in which the amplifier circuit 70 is not provided, after the electric charge averaging process, S (signal component) remains unchanged and is thus 100 μV, while N (noise) is 1/100^{0.5} of (10 μV+a thermal noise of 112 μV) and is thus 12.2 μV (hereinafter, the signal component will be referred to as “S” and the noise will be referred to as “N”). The S/N ratio is therefore 100/12.2=8.2

On the other hand, in cases as in this embodiment in which the amplifier circuit 70 is provided, a signal, in which S=10000 μV and N=1000 μV, is applied to the input line 71 from the amplifier circuit 70. In those cases, after the electric charge averaging process, S remains unchanged and is thus 10000 μV, while N is 1/100^{0.5} of (1000 μV+a thermal noise of 112 μV) and is thus 111.2 μV. The SIN ratio is therefore 10000/111.2=89.9.

That is, in this embodiment, in addition to the effects obtainable in the first embodiment, the following effects are also achievable. Even if a signal input into the noise reduction circuit is a small signal whose value is close to the value of thermal noise, the thermal noise can be reduced equivalently at the input side of the noise reduction circuit by amplifying the signal value in the early step in the noise reduction circuit. Therefore, the noise at the time of the input (that is, the noise on the signal line 5) can be reduced considerably. To be more specific, if the gain of the amplifier circuit 70 is A and the noise in the electric charge accumulating sections 2 is 65 μV, the noise at the time of the input is (65 μV/A).

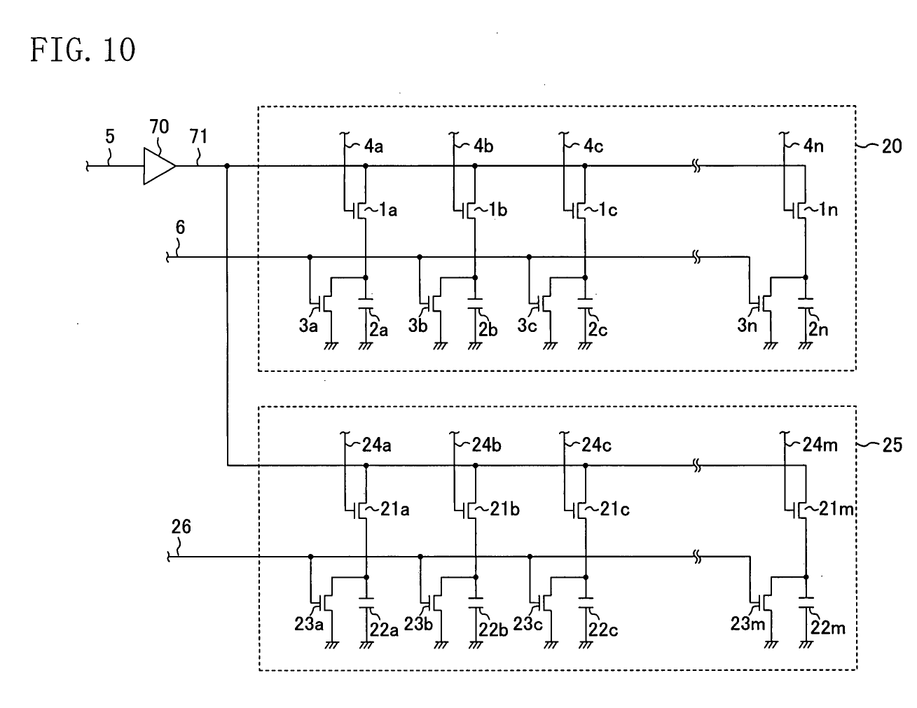

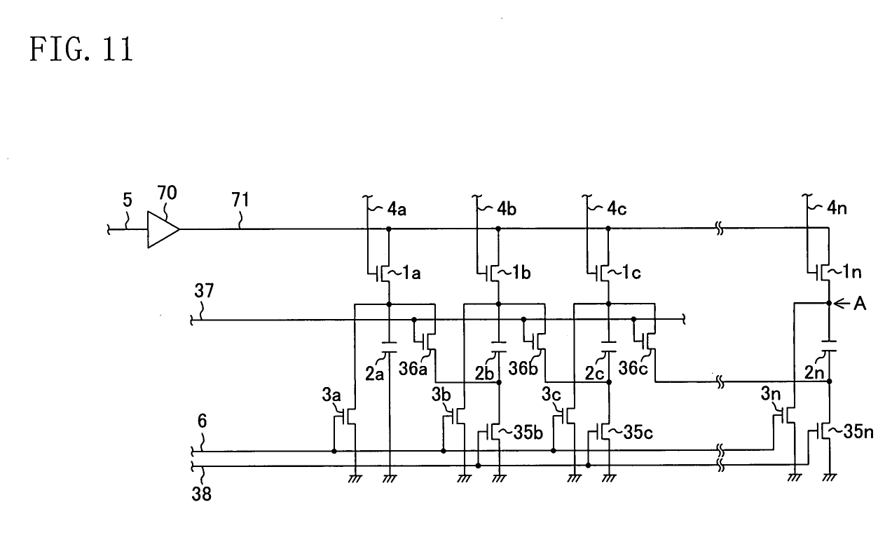

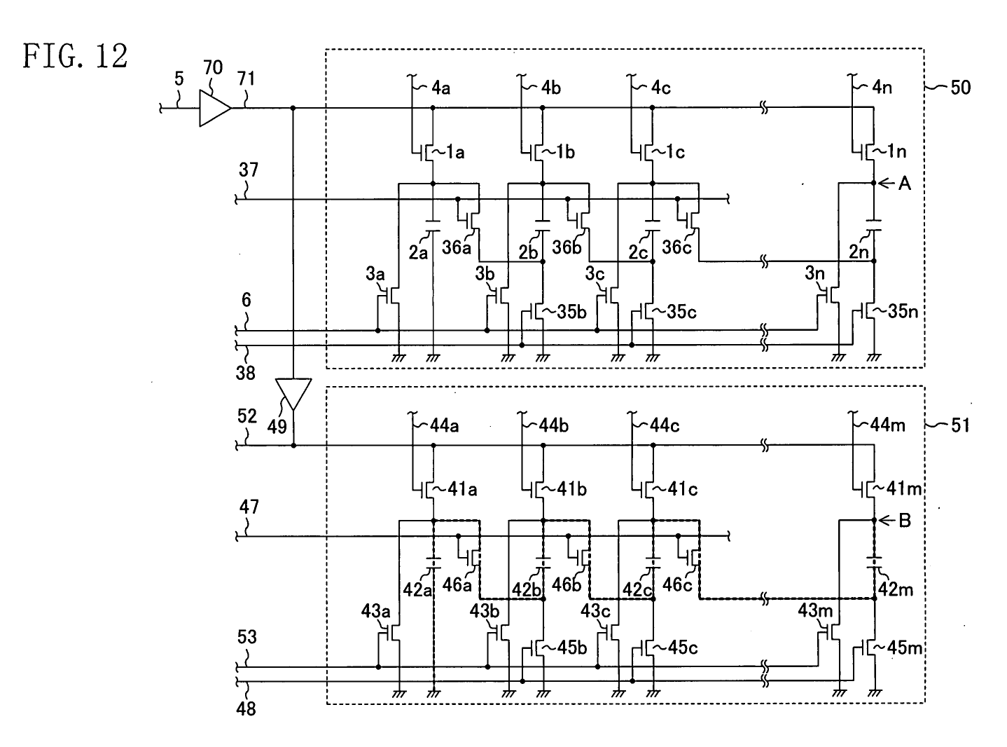

In this embodiment, the amplifier circuit is disposed in a step before the step in which the noise reduction circuit of the first embodiment shown in FIG. 1 is provided. Likewise, an amplifier circuit may be provided in a step before the noise reduction circuit of the second embodiment shown in FIG. 3 (see FIG. 10), an amplifier circuit may be provided in a step before the noise reduction circuit of the third embodiment shown in FIG. 5 (see FIG. 11), or an amplifier circuit may be provided in a step before the noise reduction circuit of the fourth embodiment shown in FIG. 7 (see FIG. 12). In those cases, the effects obtained in this embodiment are also achievable. In FIGS. 10 to 12, the same members as those of the second to fourth embodiments shown in FIGS. 3, 5, and 7 and as those of this embodiment shown in FIG. 9 are designated by the same reference numerals and descriptions of their operations and the like will be thus omitted herein.

(Sixth Embodiment)

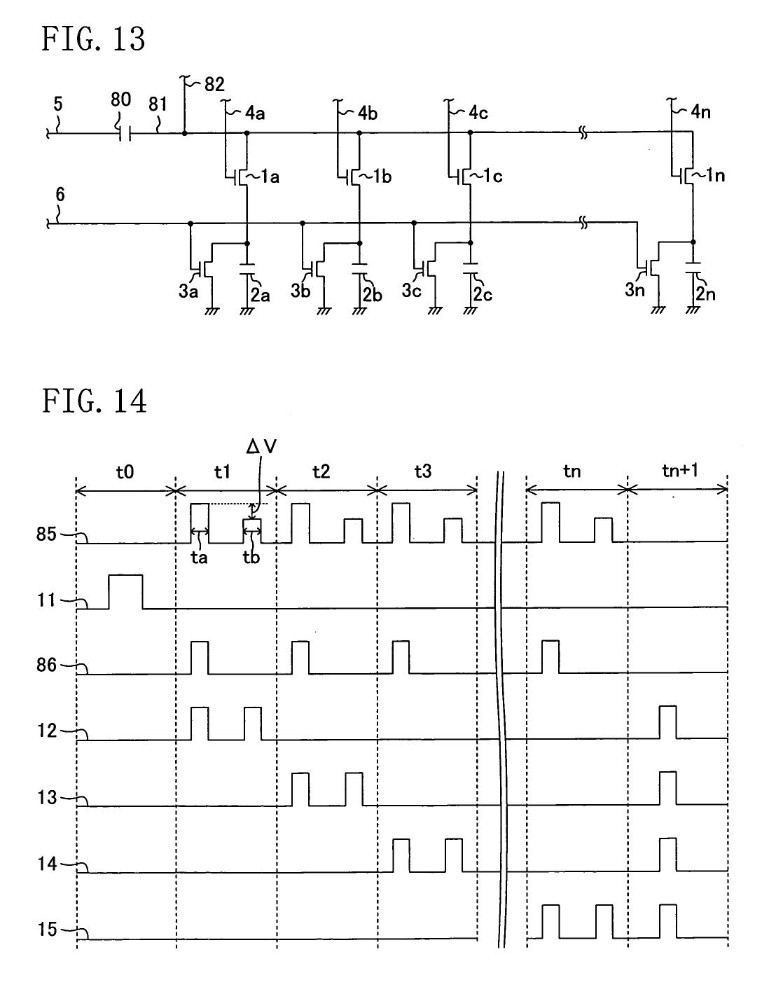

Hereinafter, a noise reduction circuit according to a sixth embodiment of the present invention will be described with reference to the accompanying drawings. FIG. 13 shows the circuit configuration of the noise reduction circuit of this embodiment. In FIG. 13, the same members as those of the first embodiment shown in FIG. 1 are designated by the same reference numerals and descriptions thereof will be thus omitted herein. As shown in FIG. 13, this embodiment differs from the first embodiment shown in FIG. 1 in that an electric charge accumulating section 80 is connected after a signal line 5 and a signal is applied to an input line 81 of the noise reduction circuit through the electric charge accumulating section 80. A terminal 82 on the input line 81, connected between the electric charge accumulating section 80 and electric charge accumulating sections 2a to 2n, is a terminal for applying a reference voltage. In other words, this embodiment is characterized in that a noise cancel circuit for removing noise by using the difference between two signals is disposed in a step before the electric charge accumulating sections 2a to 2n.

Now, it will be described how the noise reduction circuit of this embodiment operates. FIG. 14 shows timing for operating the noise reduction circuit of this embodiment. In FIG. 14, signals 11 to 15 and time periods t0 to tn+1 are the same as those of the first embodiment shown in FIG. 2 and the reference numeral 85 refers to a signal on the signal line 5 (however, the signal component thereof is the difference (ΔV) between two signals (ta and tb) based on different timings) and the reference numeral 86 refers to a signal for applying the reference voltage to the terminal 82.

As shown in FIG. 14, in the time period t0, the signal 11 to the gate terminal 6 of the switching sections 3a to 3n is set to HIGH to turn on the switching sections 3a to 3n, whereby the electric charge in each of the electric charge accumulating sections 2a to 2n is discharged so that the electric charge accumulating sections 2a to 2n are empty (i.e., the amount of electric charge accumulated in each of the electric charge accumulating sections 2a to 2n is zero). Next, during a time interval ta in the time period t1, the signal 12 that is applied to the gate terminal 4a of the switching section 1a is set to HIGH, while the signal 85 is applied to the signal line 5. This causes the switching section 1a to turn on, whereby the electric charge accumulating section 80 and the electric charge accumulating section 2a are connected in series with each other. At the same time, the signal 86 is set to HIGH to apply the reference voltage to the terminal 82. As a result, the reference voltage is applied to the connection point between the electric charge accumulating sections 80 and 2a.

Next, in a time interval tb in the time period t1, the signal 12 that is applied to the gate terminal 4a of the switching section 1a is again set to HIGH, while the signal 85 is applied to the signal line 5. This causes the switching section 1a to turn on, whereby the electric charge accumulating sections 80 and 2a are connected in series with each other. As shown in FIG. 14, the value of the signal 85 in the time interval tb is smaller than that in the time interval ta by ΔV. Therefore, the voltage at the connection point between the electric charge accumulating sections 80 and 2a in the time interval tb is expressed by the following equation:
Connection point voltage=reference voltage (i.e., reference voltage applied from the terminal 82)−ΔV×C1/(C1+C2),
where the capacitance values of the electric charge accumulating sections 80 and 2a are C1 and C2, respectively. And the amount of electric charge corresponding to this value is accumulated in the electric charge accumulating section 2a. In the above equation, the “reference voltage” is the “reference voltage applied from the terminal 82” and “ΔV×C1/(C1+C2)” is “the capacitance division of ΔV applied to the signal line 5 (C1: the capacitance value of the electric charge accumulating section 80, C2: the capacitance value of the electric charge accumulating section 2a)”.

Subsequently, the same operation as described above is performed on the electric charge accumulating sections 2b to 2n during the period of time from the time period t1 to the time period tn, and thereafter, the same operation as that performed in the time period tn+1 in the first embodiment is carried out in the time period tn+1.

In this embodiment, in addition to the effects obtainable in the first embodiment, the following effects are also achievable. By the noise cancel circuit composed of the electric charge accumulating sections 80 and 2, noise is removed using the difference between two signals as in image sensors and the like in which such noise removal is typically performed. In other words, the electric charge accumulating sections 80 and 2 together form a fixed-pattern noise removal circuit and a thermal noise reduction circuit. It is thus possible to significantly reduce thermal noise in a signal whose noise has been removed. Therefore, the noise that contains fixed-pattern noise can be reduced considerably.

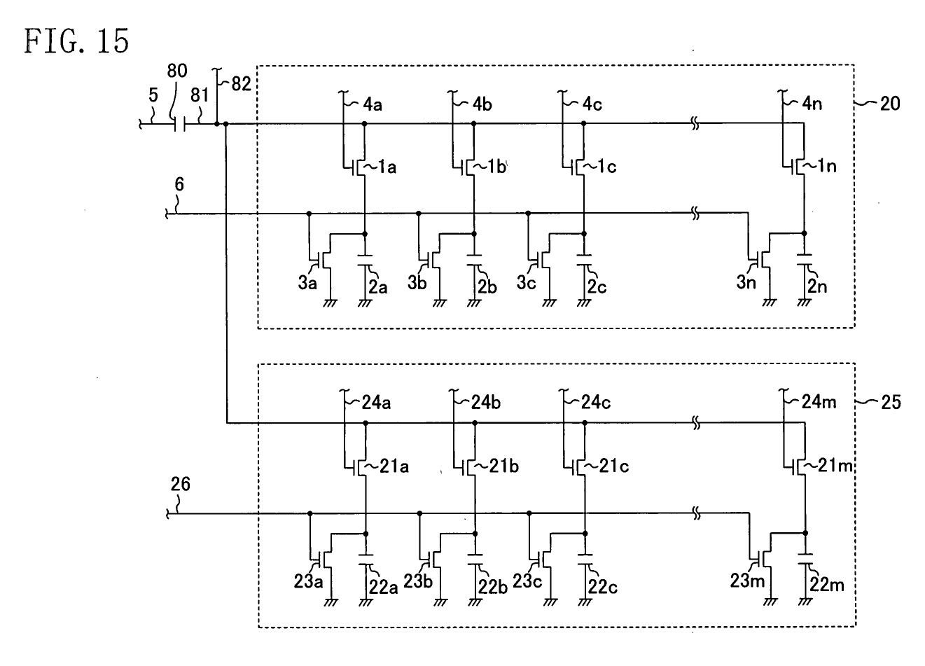

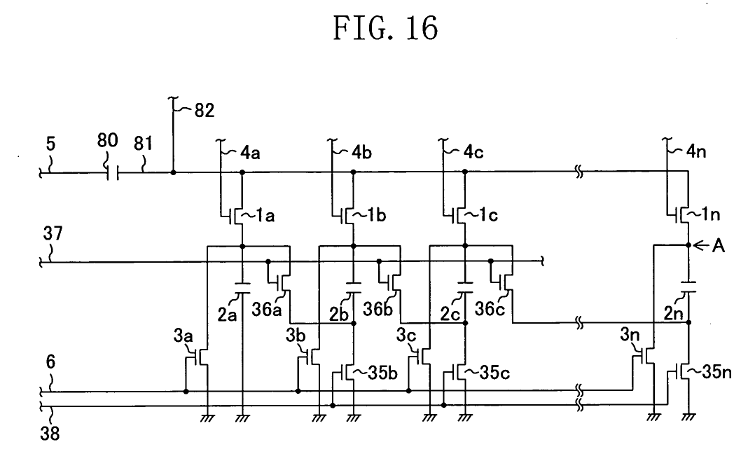

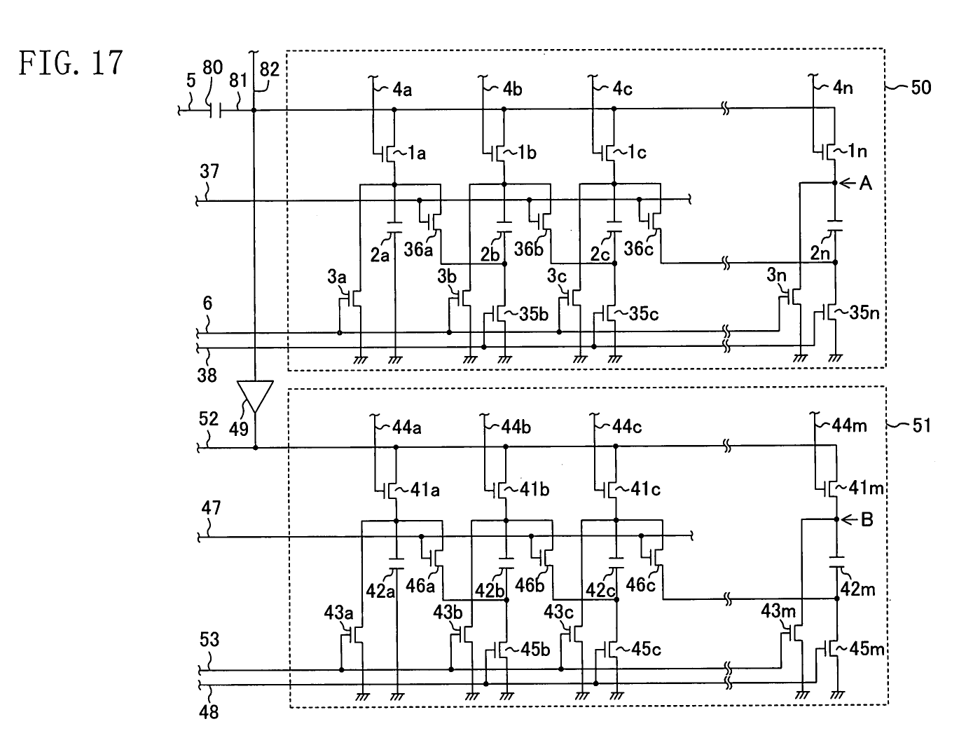

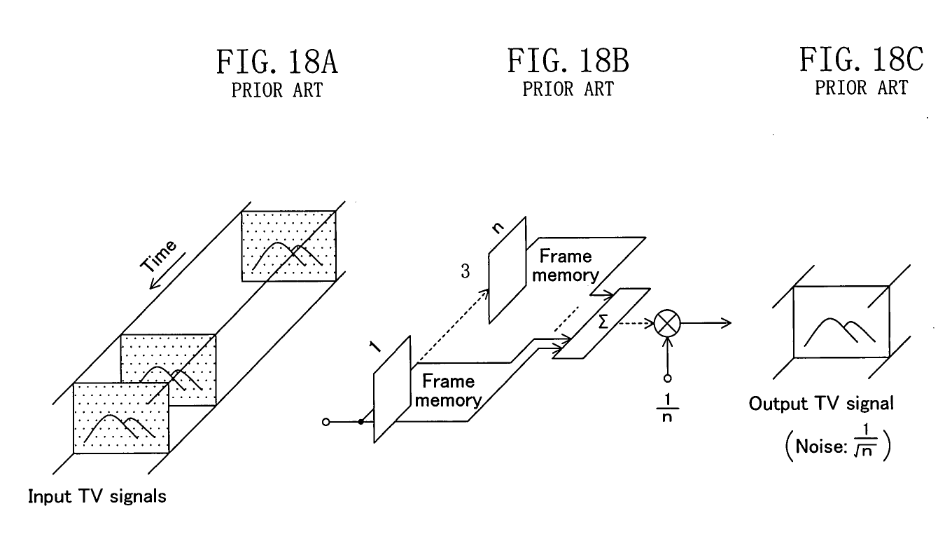

In this embodiment, the noise cancel circuit is disposed in a step before the step in which the noise reduction circuit of the first embodiment shown in FIG. 1 is provided. Likewise, a noise cancel circuit may be provided in a step before the noise reduction circuit of the second embodiment shown in FIG. 3 (see FIG. 15), a noise cancel circuit may be provided in a step before the noise reduction circuit of the third embodiment shown in FIG. 5 (see FIG. 16), or a noise cancel circuit may be provided in a step before the noise reduction circuit of the fourth embodiment shown in FIG. 7 (see FIG. 17). In those cases, the effects obtained in this embodiment are also achievable. In FIGS. 15 to 17, the same members as those of the second to fourth embodiments shown in FIGS. 3, 5, and 7 and as those of this embodiment shown in FIG. 13 are designated by the same reference numerals and descriptions of their operations and the like will be thus omitted herein.

What is claimed is:

1. A noise reduction circuit comprising:
a plurality of electric charge accumulating sections and a plurality of switching sections,
wherein electric charge in an amount corresponding to a signal containing a noise is accumulated in each of the electric charge accumulating sections, and thereafter the switching sections are turned on to connect the electric charge accumulating sections in parallel with each other, thereby outputting a signal corresponding to the average of the amounts of electric charge accumulated in the respective electric charge accumulating sections.

2. The noise reduction circuit of claim 1, wherein the electric charge accumulating sections form at least a first section group and a second section group, and
the first section group outputs the signal corresponding to the average amount of electric charge, and electric charge in an amount corresponding to that output signal is accumulated in one of the electric charge accumulating sections in the second section group.

3. The noise reduction circuit of claim 1, wherein an amplifier circuit for amplifying the signal containing the noise is disposed before the electric charge accumulating sections.

4. The noise reduction circuit of claim 1, wherein a noise cancel circuit for performing noise removal using a difference between two signals is disposed before the electric charge accumulating sections.

5. A noise reduction circuit comprising:
a plurality of electric charge accumulating sections and a plurality of switching sections,
wherein electric charge in an amount corresponding to a signal containing a noise is accumulated in each of the electric charge accumulating sections, and thereafter the switching sections are turned on to connect the electric charge accumulating sections in series with each other, thereby outputting a signal corresponding to the sum total of the amounts of electric charge accumulated in the respective electric charge accumulating sections.

6. The noise reduction circuit of claim 5, wherein the electric charge accumulating sections form at least a first section group and a second section group, and
the first section group outputs the signal corresponding to the total amount of electric charge, and electric charge in an amount corresponding to that output signal is accumulated in one of the electric charge accumulating sections in the second section group.

7. The noise reduction circuit of claim 5, wherein an amplifier circuit for amplifying the signal containing the noise is disposed before the electric charge accumulating sections.

8. The noise reduction circuit of claim 5, wherein a noise cancel circuit for performing noise removal using a difference between two signals is disposed before the electric charge accumulating sections.
